(19) United States
(12) Patent Application Publication
(10) Pub. No.: US 2010/0150229 A1
(43) Pub. Date: Jun. 17, 2010

(54) Method of Encoding and Decoding Video Images With Spatial Scalability

(76) Inventors: Edouard Francois, Bourg Des Comptes (FR); Jérôme Vieron, Bedee (FR); Nicolas Burdin, Paris (FR)

Correspondence Address: Robert D. Shedd, Patent Operations;THOMSON Licensing LLC, P.O. Box 5312, Princeton, NJ, 08543-5312, US

(21) Appl. No.: 11/990,038

(22) PCT Filed: Aug. 10, 2006
(86) PCT No.: PCT/EP2006/065221

§ 371 Date: Feb. 5, 2008

(30) Foreign Application Priority Data
Aug. 12, 2005 (FR) 0552510

(51) Int. Cl. H04N 7/32

(52) U.S. Cl. 375/240.12; 375/E07.243

(57) ABSTRACT

The invention relates to a method of encoding and decoding video images with spatial scalability. The inventive method comprises the following steps consisting in: encoding (5) a low-resolution image, by performing a calculation of a local or reconstructed decoded image, in order to supply an encoded low-resolution image; oversampling (6) the reconstructed image in order to supply a prediction image; and encoding (7) a higher resolution image, comprising a difference calculation with the prediction image in order to supply residues. The invention is characterised in that the method also comprises a step consisting in selecting or calculating filter coefficients to be used for oversampling and a subsequent step consisting in encoding said coefficients such that they can be transmitted to the decoder with the other encoded data. The invention is suitable for hierarchical encoding with spatial scalability.

The invention relates to a device and method of coding and decoding video pictures with spatial scalability, more particularly a first low resolution picture and at least one second picture of higher resolution from the low resolution picture, the first and second pictures having a common video part. The domain is that of hierarchical coding with spatial scalability and ESS, acronym for extended spatial scalability.

Spatial scalability represents the capacity to scale the information to make it decodable at several levels of resolution and/or quality. More precisely, a data stream generated by the coding device is divided into several layers, particularly a base layer and one or more improvement layers. These devices particularly enable a unique data stream to be adapted to variable transport and display conditions. For example, in the particular case of spatial scalability, the part of the data stream corresponding to the low resolution pictures of the sequence can be coded separately from the part of the data stream corresponding to the high resolution pictures.

Hierarchical coding with spatial scalability enables a first part of data called base layer to be coded, relative to the low resolution format, and from this base layer a second data part called improvement layer, relative to the high resolution format. The additional data relative to the improvement layer are generally generated according to a method comprising the following steps:
coding of the low resolution picture and possibly local decoding of said picture to obtain a reconstructed picture,
scaling or over-sampling of the reconstructed low resolution picture, for example by interpolation and filtering, to obtain a prediction picture in high resolution format, and
difference, pixel by pixel, of the luminance values of the source picture and of the prediction picture to obtain residues in relation to the improvement layer, when the inter-layer coding mode is selected.

Thus the coding of the high resolution picture uses the low resolution picture scaled as prediction picture. The method is also applied to the chrominance pictures if they exist.

On the decoder side, the decoding method performs the reverse operations:
decoding the low resolution picture to obtain a reconstructed picture,
scaling or over-sampling of the reconstructed low resolution picture, for example by interpolation and filtering, to obtain a prediction picture in high resolution format, and
addition, pixel by pixel, of the residues relating to the improvement layer to the luminance values of the prediction picture.

The different decoding operations are normative, in particular the decoder carries out the over-sampling operations of the pictures of the base layer with filters predefined in the specification of the standard.

The coding operations are not normative. However, the local decoding operations performed by the coder to calculate the reconstructed picture must preferably be similar to the operations carried out by the decoder, to obtain a same reconstructed picture from which the residues are calculated, thus preventing any problem of drift at the decoding level.

It is also preferable that the subsampling operations of the high resolution picture, in the case where it is used to obtain the low resolution picture to code, correspond to the over-sampling operations of the reconstructed low resolution picture so that the high resolution prediction picture thus obtained and from which are calculated the residues for the improvement layer, can also be as faithful as possible to the source high resolution picture. The coefficients of the analysis filters must be suitable to those of the synthesis filters.

As a consequence, an optimisation of the filters used by the coder cannot be realised. Indeed, such an optimisation would lead to a degradation in the quality of the pictures owing to the fact of using different over-sampling filters in the coder and the decoder or owing to the fact of using uncorrelated over-sampling and subsampling filters.

One of the purposes of the invention is to overcome the aforementioned disadvantages. For this reason, the purpose of the invention has a method of coding video pictures with spatial scalability realising the coding of a first low resolution picture and of at least one second picture of higher resolution from the low resolution picture, the first picture having a common video part with the second picture, comprising
a coding step of the low resolution picture carrying out a calculation of a local or reconstructed decoded picture, to provide a coded low resolution picture,
an over-sampling step of the reconstructed picture to provide a prediction picture,
a coding step of the higher resolution picture comprising a calculation of difference with the prediction picture to provide the residues,
characterized in that it also comprises a step of selecting or calculating coefficients of filters to use for the over-sampling then a step of coding the coefficients to be transmitted to the decoder with the other coded data.

According to a particular implementation, the coefficients of the filters depend on the video content of a picture, a shot of a sequence of pictures or a sequence of pictures.

According to a particular implementation, the coefficients of the over-sampling filters depend on the bitrate or quality required for the high resolution picture.

According to a particular implementation, the method comprising a subsampling step of a source picture of higher resolution to provide the low resolution picture to code, is characterized in that the coefficients of the subsampling filters depend on the coefficients of the over-sampling filters.

According to a particular implementation of this method, the coefficients of the over-sampling filters depend on the video content of a picture, a shot of a sequence of pictures or a sequence of pictures.

According to a particular implementation, the coefficients of the over-sampling filters depend on the levels and profiles used for the coding.

The invention also relates to a decoding method of video pictures from a data stream comprising a base layer for coding a low resolution picture and at least one improvement layer for coding a higher resolution picture from residues, comprising
a decoding step of the low resolution picture to provide a reconstructed low resolution picture,
an over-sampling step of the reconstructed low resolution picture to provide a prediction picture,
a decoding step of the high resolution picture comprising an addition of residues to the prediction picture,

characterized in that it also comprises a decoding step of filter coefficients transmitted in the data stream for the calculation of the filters used for the over-sampling.

According to a particular implementation, the data stream comprising at least two improvement layers, the method comprises a decoding step of at least a first and second set of filters to produce respectively a first filtering for the over-sampling of the low resolution picture into a higher resolution picture and a second filtering for the over-sampling of the higher resolution picture into a picture of higher resolution.

The invention also relates to a data stream comprising a base layer relative to a low resolution picture and a top layer relative to a higher resolution picture, characterized in that it comprises a data field comprising values of digital filter coefficients intended to be used for the over-sampling of the low resolution picture, to supply a prediction picture used, with the data of the top layer, for the decoding of the high resolution picture.

The idea is therefore to enable the use of proprietary filters, by adding into the syntax of the data stream elements or fields describing the filters to use for the over-sampling at the decoder level.

By means of the transmission, in the stream, of some extra data relating to the filters and/or filter coefficients, the coder can adapt the over-sampling filters, the decoder being able to reproduce the same over-sampling operations as the coder, thus preventing phenomena of temporal drift.

For example, the filters used can be selected according to the video content of the sequence of pictures, a shot of the sequence or the picture. They can also be chosen according to the spatial resolution targeted, accurate filters for high resolutions, more approximate for low resolutions. Another criterion can be the complexity of display devices of the decoder, simpler filters thus being implemented when decoders of a lower calculation power are involved.

It is also possible to arbitrate between the complex over-sampling filters and therefore a better quality of the prediction picture for the calculation of the residues of the improvement layer giving a better rate of compression and simpler over-sampling filters reducing the processing time.

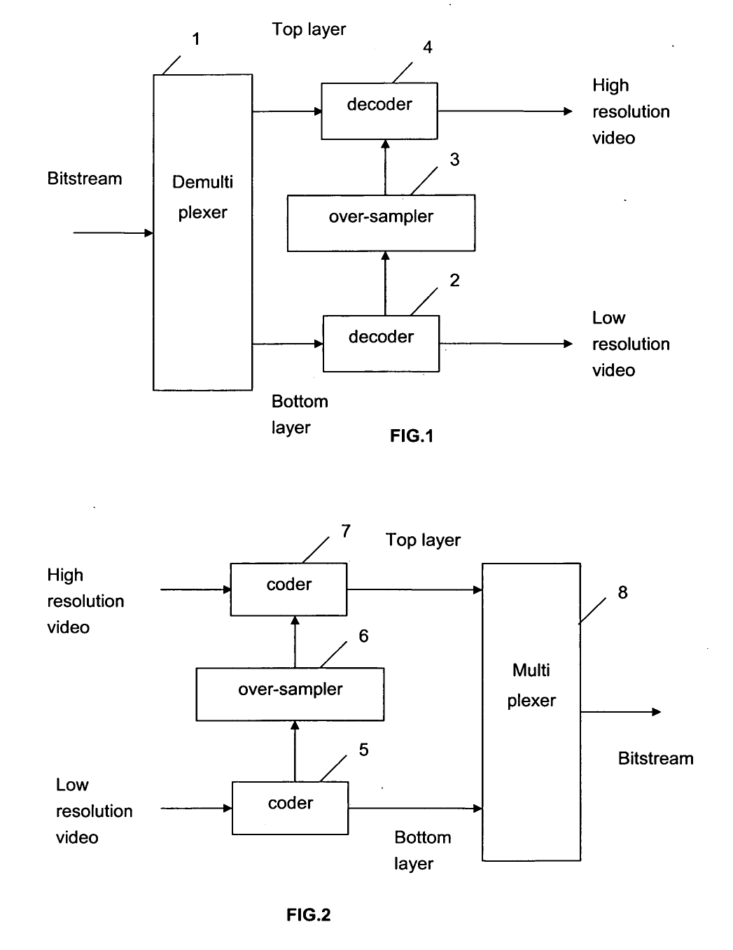

FIG. 1 show in a diagrammatic manner a scalable decoding circuit, according to the invention.

The bitstream received by the scalable decoder is sent to a demultiplexing circuit 1 that separates the data relating to the base layer or bottom layer and the data relating to the improvement layer or top layer. The data relating to the base layer are sent to a low resolution decoder 2 that performs in a standard manner the decoding of the information of the base layer to provide a low resolution picture at the output. The reconstructed pictures of the low resolution decoder are sent to an over-sampling circuit 3

This circuit receives, for example from the demultiplexing circuit 1 or from the central processing unit not shown in the figure, the data relating to the digital filters to configure to perform the over-sampling and filtering operations. The picture thus over-sampled and filtered or prediction picture is then sent to the high resolution decoder 4 on a second input, the first input receiving the data relating to the improvement layer coming from the demultiplexer 1. The residues are added to the prediction picture to give a high resolution picture at the output.

FIG. 2 shows a part of the scalable coding diagram according to the invention.

A low resolution picture is sent on the input of a low resolution coder 5 that performs a coding operation on said picture to provide, on a first output, compressed data constituting the base layer or bottom layer, data sent to a multiplexer 8. On a second output, a reconstructed picture coming from the local decoder, decoder enabling, in a known manner, the coded pictures to be reconstructed to calculate the predicted pictures to take advantage of the temporal correlation, is sent to an over-sampling circuit 6. Said circuit performs a filtering and over-sampling operation of the reconstructed picture from digital filters to provide a prediction picture. Said circuit is linked to a first processing circuit not shown in the figure, that calculates the coefficients of the digital filters to implement, to transmit them to the over-sampling circuit.

The prediction picture calculated by the circuit 6 is sent, on a first input, to a high resolution coder 7. Said coder receives, on a second input, the data relating to the source high resolution picture. The coder calculates, among other things, in a known manner, the residue that is the difference between the high resolution picture and the prediction picture to supply at the output data corresponding to the improvement layer or high resolution layer. This data is sent to the multiplexing circuit 8 that performs the multiplexing with the data of the base layer to provide the data stream or bitstream at the output of the coder.

The multiplexing circuit also comprises a second processing circuit, also not shown in the figure, that has the function of configuring the data stream sent by the coders according to particular syntax. According to the invention, the syntax comprises fields, for example at the sequence or slice (according to the MPEG standard) level, attributed to these filters. Hence, the coefficients calculated by the first processing circuit are sent to the second processing circuit to be inserted into the suitable fields so as to be sent to the decoder by means of the data stream.

Naturally, the processing circuits can be a same central processing unit or be arranged differently, for example in a coder, the calculation of the filters and the integration of the data of the filters into the stream being made at the level of a layer.

The described part of the coding device receives at the input at least two picture sequences, one at the low resolution format and one at the high resolution format. These two sequences can for example be supplied by a content creator. The coding device can also include a subsampling module that can directly generate the sequence of low resolution pictures from the sequence of source high resolution pictures. This device thus receives at the input a single picture sequence in high resolution format.

According to this device, an improvement of the invention consists in calculating, from coefficients of the digital filters used by the over-sampling circuit 6, the digital filter coefficients used by the subsampling circuit of the source high resolution picture enabling the low resolution picture to be obtained or conversely. It is possible for example, from determined analysis filters for the subsampling, to calculate the additional synthesis filters for the over-sampling according to the approach described in the document “R. Ansari, C. W. Kim, and M. Dedovic. Structure and design of two-channel filter banks derived from a triplet of half band filters. IEEE Transactions on Circuits and Systems II, 46(12):1487-1496, December 1999.”. The inverse approach inverse, consisting in from a synthesis filter and in deriving the analysis filter, as in the document above, can also be adopted.

The low resolution and/or high resolution coding circuits are for example of the type H264AVC, or its extension SVC, acronym for Scalable Video Coding, that enables the scalable coding to be addressed. The filters used for the over-sampling and/or subsampling are for example polyphase linear filters, for which the coefficients are dependent on the position of the pixels to interpolate.

In general, it is thus possible to use the over-sampling and/or subsampling filters according to the content of the picture, a complex filter being for example set up for a highly textured picture, a simple filter for a uniform picture. The type of filter used can be a function of the texture of the picture, by avoiding for example the use of Lanczos filters for highly textured pictures, filters generating an extremely unpleasant aliasing that is penalising for the compression. The filters can vary between two sequence shots if the video content changes, simple filter for a first shot corresponding to a scene with strong movement as in this case the texture is generally not accurate and its details are not perceived by the eye, complex filter for the next shot comprising a slightly moving scene, as the texture is then much more visible and must therefore be correctly over-sampled. An analysis or pre-analysis of the picture or the sequence of pictures can be used to calculate the filters.

According to an implementation example, the complexity of the filters used for the over-sampling of the reconstructed low resolution picture depends on the available resources of the receiver used in the decoder. For example, a low resolution layer and a higher resolution layer correspond to data to display respectively on a mobile phone screen and on an organiser screen also called personal digital assistant. It is then possible to reduce the over-sampling calculations by simplifying the filtering, which enables the resources of the organiser to saved. This is to the detriment of a slight drop in quality of the picture to display. For example, for a given combination of profile and level (profile/level, as defined in the standards of type MPEG-2 or MPEG-4 AVC), a type of filter or filter coefficients are associated.

According to another implementation example, the over-sampling filters are different according to the layers used. By adding, to the previous example, a high resolution layer for the display on a television screen, simplified filters are used for the over-sampling of the low resolution picture enabling a higher resolution picture to be obtained for the display on an organiser, more complex filters are used for the over-sampling of the higher resolution picture enabling a high resolution picture to be obtained for the display on a television screen.

According to another implementation example, the over-sampling filter on the coder, and therefore also on the decoder, is selected from a picture quality or compression rate/processing time or capacity compromise. The reconstructed picture being more faithful to the source high resolution picture when the use of complex filters requiring a longer processing time, the quality of the high resolution picture is improved and the coding cost is reduced.

For example, it is considered that the filters used are linear filters, possibly polyphase, separable, the two-dimensional filtering being able to be carried out by filtering separately in one dimension then in the other. Hence, the filters are mono-dimensional.

The following method, being based on the resolution of the pictures, can be implemented:
if the over-sampling converts from QCIF format (Quarter Common Intermediate Filter) (176 columns per 144 lines) to the CIF format (Common Intermediate Filter) (352 columns per 288 lines), the over-sampling filter used is as follows:

monophase filter

{½; ½}
if the over-sampling converts from CIF format to 4CIF format (704 columns per 576 lines), the over-sampling filter used is as follows:

monophase filter

{ 1/32; − 5/32; 20/32; 20/32; − 5/32; 1/32}

This filter is the one used by default in the current version of the SVC standard in the progress of definition
if the over-sampling converts from QCIF or CIF format to any higher format having a ratio of horizontal and vertical size other than 2:

4-coefficient polyphase filter based on the Lanczos filter described in the following table (the coefficients must be divided by 128):

| | |
|---|---|
| phase | filter coefficients |

| | | | | |
|---|---|---|---|---|
| 0 | 0 | 128 | 0 | 0 |
| 1 | 4 | 127 | 5 | 0 |
| 2 | 8 | 124 | 13 | 1 |
| 3 | −10 | 118 | 21 | −1 |
| 4 | 11 | 111 | 30 | 2 |
| 5 | −11 | 103 | 40 | −4 |
| 6 | 10 | 93 | 50 | 5 |
| 7 | 9 | 82 | 61 | 6 |
| 8 | −8 | 72 | 72 | −8 |
| 9 | 6 | 61 | 82 | −9 |
| 10 | 5 | 50 | 93 | 10 |
| 11 | −4 | 40 | 103 | −11 |
| 12 | 2 | 30 | 111 | 11 |
| 13 | 1 | 21 | 118 | 10 |
| 14 | −1 | 13 | 124 | −8 |
| 15 | 0 | 5 | 127 | 4 |

if the over-sampling converts from 4CIF format to any higher format (for example to 720p format-1280 columns per 720 lines), the over-sampling filter used is as follows:

6-coefficient polyphase filter based on the Lanczos filter described in the following table (the coefficients must be divided by 32):

| | |
|---|---|
| phase | filter coefficients |

| | | | | | | |
|---|---|---|---|---|---|---|
| 0 | 0 | 0 | 32 | 0 | 0 | 0 |
| 1 | 0 | −2 | 32 | 2 | 0 | 0 |
| 2 | 1 | −3 | 31 | 4 | −1 | 0 |
| 3 | 1 | −4 | 30 | 7 | −2 | 0 |
| 4 | 1 | −4 | 28 | 9 | −2 | 0 |
| 5 | 1 | −5 | 27 | 11 | −3 | 1 |
| 6 | 1 | −5 | 25 | 14 | −3 | 0 |
| 7 | 1 | −5 | 22 | 17 | −4 | 1 |
| 8 | 1 | −5 | 20 | 20 | −5 | 1 |
| 9 | 1 | −4 | 17 | 22 | −5 | 1 |
| 10 | 0 | −3 | 14 | 25 | −5 | 1 |
| 11 | 1 | −3 | 11 | 27 | −5 | 1 |
| 12 | 0 | −2 | 9 | 28 | −4 | 1 |
| 13 | 0 | −2 | 7 | 30 | −4 | 1 |
| 14 | 0 | −1 | 4 | 31 | −3 | 1 |
| 15 | 0 | 0 | 2 | 32 | −2 | 0 |

This solution enables 4 levels of spatial scalability to be processed, QCIF, CIF, 4CIF, greater than 4CIF, with ad hoc filters according to the level of spatial resolution and the inter-layer size ratio considered.

According to a particular implementation of the invention, the syntax relating to the SVC standard, that uses predefined filters, is modified. Said SVC syntax is described for example in the document Joint Video Team (JVT) of ISO/IEC MPEG & ITU-T VCEG (ISO/IEC JTC1/SC29/WG11 and ITU-T SG 16 Q.6), 15th meeting, Busan, KR, 16-22 Apr., 2005.

The following parameters and fields are added to the syntax of the bitstream in the following manner:
at the sequence level:
   a variable, named load coef. This variable can have the following values:

load coef=0, in this case, the default over-sampling technique is applied
load coef=1, ad hoc coefficients are coded into the bitstream at sequence level and are therefore then applied to all the pictures of the sequence
load coef=2, ad hoc coefficients are coded into the bitstream at picture level and are therefore then applied to the picture to which they are associated
   If load coef=1, the coefficients of the filters are coded into the syntax at the sequence level. The syntax described in the table 1 below (sequence level syntax) shows the manner in which these coefficients can be coded.
at the picture level:
   If load coef=2, the coefficients of the filters are coded into the syntax at the picture level. The syntax described in the table 2 below (slice level syntax) shows the manner in which these coefficients can be coded.
   The coefficients of the previous slice can therefore be used without recoding them by signalling this in the bitstream (samecoef_as_previous_slice=1). The syntax is in fact described at the level of a slice that, according to the standard, is a continuous series of macroblocks. Here, the description is restricted to a slice constituted by the set of macroblocks of the picture and thus assimilated to a picture, the solution usually adopted. But it is naturally possible, according to this syntax, to use different filters for particular zones of the picture corresponding to slices.

The following tables are an example of syntax for the data stream. The method of description of the syntax of the bitstream uses the convention of the “C code”. It corresponds to the method used in the description of the MPEG or H264 standards; it is thus found, to give examples, in documents such as ISO/CEI 13818-2 or JVT-0202 entitled “Joint Scalable Video Model JSVM 2”, 15th meeting, Busan, KR.

Table 1 corresponds to the syntax to add to the syntax relative to the sequence level, the filters then being able to be renewed at each sequence.

Table 2 corresponds to the syntax to add to the syntax relative to the slice level, the filters then being able to be renewed at each slice of the picture.

TABLE 1
Sequence level syntax

load_coef
If (load_coef = = 1) {

number_of_filters_seq
number_of_coefs_seq
for (nf=0 ; nf< number_of_filters_seq ; nf++) {

for (nc=0 ; nc< number_of_coefs_seq ; nc++) {

coef_seq[nf][nc]

}

}

}

TABLE 2
Slice level syntax

If (load_coef = = 2) {

same_coef_as_previous_slice
if (same_coef_as_previous_slice = = 0) {

number_of_filters_pic
number_of_coefs_pic
for (nf=0 ; nf< number_of_filters_pic ; nf++) {

for (nc=0 ; nc< number_of_coefs_pic ; nc++) {

coef_pic[nf][nc]

}

}

}

}

Tables 3 and 4 describe this syntax in a more explicit manner:

TABLE 3

| | |
|---|---|
| Sequence level syntax | comments |

coding of the ‘load_coef’ parameter
If (load_coef is equal to 1)

| | |
|---|---|
| coding of the ‘number_of_filters_seq’ parameter | |
| coding of the ‘number_of_coefs_seq’ parameter | |
| From nf=0 to number_of_filters_seq | loop on the filters |

| | |
|---|---|
| From nc=0 to number_of_coefs_seq | loop on the coefficients |

| | |
|---|---|
| coding of the ‘coef_seq[nf][nc]’ | number coefficient nc of the |

| | |
|---|---|
| parameter | number filter nf |
| } | |

TABLE 4

| | |
|---|---|
| Slice level syntax | comments |

If (load_coef is equal to 2)

coding of the flag ‘same_coef_as_previous_slice’
If (same_coef_as_previous_slice is equal to 0)

coding of the ‘number_of_filters_pic’

parameter

coding of the ‘number_of_coefs_pic’

parameter

| | |
|---|---|
| From nf=0 to number_of_filters_pic | loop on the filters |

| | |
|---|---|
| From nc=0 to number_of_coefs_pic | loop on the coefficients |

| | |
|---|---|
| coding of the ‘coef_pic[nf][nc]’ | number coefficient nc of |

| | |
|---|---|
| parameter | the number filter nf |

By default, it is considered that an over-sampling technique, and if necessary, the corresponding coefficients, is available. In the event of non-transmission in the bitstream of proprietary coefficients, it is this technique that is applied.

At the level of the coding/decoding process, the modifications are directly linked to the modifications of syntax. Only the part relating to the texture is considered:
If load coef=0, the default texture over-sampling technique is applied.
Otherwise, if load coef=1, the texture over-sampling of the low resolution pictures is carried out with the coded/decoded filter coefficients at the sequence level coef seq.
Otherwise, if load coef=2, the texture over-sampling is carried out on each low resolution picture with the coded/decoded filter coefficients at the picture level coef_pic, being applied to this picture.

The coefficients of the over-sampling filters can be calculated by the coder. They can also be selected by the coder from a set of predetermined filters stored in a memory of the coder. It is by means of the transmission of the parameters of the filters to the decoder that it is possible to adapt the filtering to the coding. The filters used in the decoding for the over-sampling are thus determined during the coding.

An extension of the approach proposed consists in standardising a set of predefined filters at the decoder. Moreover, ad hoc filters can also be signalled in the syntax, as is described in the invention, and stored by the decoder. Hence, the decoder at any moment has a set of potential filters, stored in memory and indexed by a number. The indices of the filters to use can then by sent to the decoder, specifying what filters it must use, without needing to explicitly send the coefficients of these filters. If at a given moment new filters must be used, they are coded into the syntax with their associated index.

1. Coding method of video pictures with spatial scalability realising the coding of a first low resolution picture and of at least one second picture of higher resolution from the low resolution picture, the first picture having a common video part with the second picture, comprising
a coding step of the low resolution picture carrying out a calculation of a local or reconstructed decoded picture, to provide a coded low resolution picture,
an over-sampling step of the reconstructed picture to provide a prediction picture,
a coding step of the higher resolution picture comprising a calculation of difference with the prediction picture to provide the residues,
also comprising a step of selecting or calculating coefficients of filters to use for the over-sampling then a step of coding the coefficients to be transmitted to the decoder with the other coded data.

2. Coding method according to claim 1, wherein the coefficients of the filters depend on the video content of a picture, a shot of a sequence of pictures or a sequence of pictures.

3. Method according to claim 1, wherein the coefficients of the over-sampling filters depend on the bitrate or quality required for the high resolution picture.

4. Method according to claim 1 comprising a subsampling step of a source picture of higher resolution to provide the low resolution picture to code, wherein the coefficients of the subsampling filters depend on the coefficients of the over-sampling filters.

5. Method according to claim 4, wherein the coefficients of the over-sampling filters depend on the video content of a picture, a shot of a sequence of pictures or a sequence of pictures.

6. Method according to claim 1, wherein the coefficients of the over-sampling filters depend on the levels and profiles used for the coding.

7. Decoding method of video pictures from a data stream comprising a base layer for the coding of a low resolution picture and at least one improvement layer for the coding of a higher resolution picture from residues, comprising
a decoding step of the low resolution picture to provide a reconstructed low resolution picture,
an over-sampling step of the reconstructed low resolution picture to provide a prediction picture,
a decoding step of the high resolution picture comprising an addition of residues to the prediction picture,
also comprising a decoding step of filter coefficients transmitted in the data stream for the calculation of the filters used for the over-sampling.

8. Method according to claim 7, the data stream comprising at least two improvement layers, comprising a decoding step of at least a first and second set of filters to realize respectively a first filtering for the over-sampling of the low resolution picture into a higher resolution picture and a second filtering for the over-sampling of the higher resolution picture into a picture of higher resolution.

9. Data stream comprising a base layer relating to a low resolution picture and a top layer relating to a higher resolution picture, also comprising a data field comprising values of digital filter coefficients intended to be used for the over-sampling of the low resolution picture, to provide a prediction picture used, with the data of the top layer, for the decoding of the high resolution picture according to the method of claim 7.
